(19) United States
(12) Patent Application Publication
(10) Pub. No.: US 2010/0034504 A1
(43) Pub. Date: Feb. 11, 2010

(54) Melt Processible Semicrystalline Fluoropolymer Comprising Repeating Units Arising from Tetrafluoroethylene and a Hydrocarbon Monomer Having a Functional Group and a Polymerizable Carbon-Carbon Double Bond, and Multilayer Articles Therefrom

(75) Inventors: Ralph Munson Aten, Chadds Ford, PA (US); Sharon Ann Libert, Hockessin, DE (US); Craig King Hennessey, Avondale, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/511,316

(22) Filed: Jul. 29, 2009

Related U.S. Application Data
(60) Provisional application No. 61/087,388, filed on Aug. 8, 2008.

(51) Int. Cl. G02B 6/02; C08F 214/26; C08F 214/28; B32B 27/06; B32B 27/08; B32B 1/08; B29C 47/78; B28B 7/38; B29C 47/88; H01B 3/44

(52) U.S. Cl. 385/123; 526/255; 526/253; 428/421; 428/412; 428/36.91; 425/436 R; 427/133; 264/319; 174/110 FC

(57) ABSTRACT

Disclosed is a melt processible semicrystalline fluoropolymer comprising: (a) about 0.001 to about 25 weight percent of repeating units arising from a hydrocarbon monomer having a functional group and a polymerizable carbon-carbon double bond, wherein said functional group is at least one selected from the group consisting of amine, amide, hydroxyl, phosphonate, sulfonate, nitrile, boronate and epoxidehydrocarbon monomer; and (b) the remaining weight percent of repeating units arising from tetrafluoroethylene. This melt processible semicrystalline fluoropolymer is impermeable to fuels and is useful as a lining for petroleum fuel tubing, as well as chemical resistance coating for, or adhesive between, perfluoropolymer and other polymers, metals and inorganics.

### FIELD OF THE DISCLOSURE

This disclosure relates in general to a melt processible semicrystalline fluoropolymer having repeating units arising from tetrafluoroethylene and a hydrocarbon monomer having a functional group and a polymerizable carbon-carbon double bond.

### BACKGROUND

Fluorine containing polymers are important commercial products due to their low surface energy and high thermal and chemical resistance. However, often their low surface energy leads to poor adhesion to substrates.

Certain functional groups are known to modify the adhesive properties of partially fluorinated polymers. Incorporation of such groups during polymerization of partially fluorinated polymers without significantly sacrificing desirable polymer properties has been met with limited success to date. Monomers containing functional groups may not copolymerize with fluorinated monomers or may cause other undesirable effects in a copolymerization. Further, incorporation of monomers containing functional groups can adversely affect the thermal stability or chemical resistance of the resulting polymer.

Thus, there is a need for thermally stable and chemically resistant fluorine containing polymers that also have adhesive properties.

Partially fluorinated polymer coatings can be formed on metal substrates by known processes wherein a metal surface is roughened and a primer is coated, followed by particles of a partially fluorinated polymer being deposited thereon and then melted. Such metal roughening and use of primer adds complexity and cost to an industrial process.

Thus, there is a need for thermally and chemically resistant fluoropolymers that also have adhesive properties to metals without requiring primers or metal surface roughening.

Multi-layer articles having layers of fluoropolymer and polyamide find use in fuel service in devices powered by internal combustion engines. In such articles, it is necessary that adjacent layers of fluoropolymer and polyamide are adhered to one another.

One commercial method involves subjecting a fluoropolymer tube to surface treatment by a chemical reagent, corona discharge treatment or plasma discharge treatment. Non-fluorinated polymer such as polyamide is then extruded onto the outer surface of the so-modified fluoropolymer tube. Such an adhering method adds complexity and cost to, and reduces the productivity of, this industrial process.

Thus, there is a need for a fluoropolymer which does not require such surface treatment and whereby it is possible to form at reasonable processing temperatures a multi-layer article with non-fluorinated polymer by melt processing methodology such as coextrusion.

### SUMMARY

Melt processible semicrystalline fluoropolymer is described herein that meets industry needs by strongly adhering to a variety of substrates, by being melt processible under reasonable processing conditions using conventional methodology, and by having thermal and chemical resistance of utility in a range of commercial applications.

Described herein is a melt processible semicrystalline fluoropolymer comprising: (a) about 0.001 to about 25 weight percent of repeating units arising from a hydrocarbon monomer having a functional group and a polymerizable carbon-carbon double bond, wherein the functional group is at least one selected from the group consisting of amine, amide, hydroxyl, phosphonate, sulfonate, nitrile, boronate and epoxide; and (b) the remaining weight percent of repeating units arising from tetrafluoroethylene (also referred to herein as TFE).

Further described herein is a multilayer article comprising: (A) a first layer comprising a substrate; and (B) a second layer comprising the aforementioned melt processible semicrystalline fluoropolymer; wherein (A) and (B) are in contiguous contact.

Further described herein is a multilayer tube comprising: (A) a first layer comprising a non-fluorinated polymer having polar functionality; and (B) a second layer comprising the aforementioned melt processible semicrystalline fluoropolymer; wherein the layers are arranged concentrically such that the first layer (A) is outside of the second layer (B) and the outer face of the second layer (B) is in contiguous contact with the inner face of the first layer (A).

Further described herein is an insulated wire comprising: (A) a wire comprising metal; and (B) a layer comprising the aforementioned melt processible semicrystalline fluoropolymer; wherein (A) and (B) are in contiguous contact.

Further described herein is a melt extrusion die having a flow passage coated with a composition comprising the aforementioned melt processible semicrystalline fluoropolymer.

Further described herein is a process for melt extruding a polymer, comprising: (A) coating the flow passage of a melt extrusion die with the aforementioned melt processible semicrystalline fluoropolymer to form a coated melt extrusion die; and (B) melt extruding a polymer through the coated melt extrusion die.

Further described here is an optical fiber comprising: (A) a fiber comprising an inorganic substrate; and (B) a layer comprising the aforementioned melt processible semicrystalline fluoropolymer; wherein (A) and (B) are in contiguous contact.

The foregoing general description and the following detailed description are exemplary and explanatory only and are not restrictive of the invention, as defined in the appended claims.

### BRIEF DESCRIPTION OF THE DRAWINGS

Embodiments are illustrated in the accompanying figures to improve understanding of concepts presented herein.

FIG. 1 illustrates a cross-sectional view of a present multilayer article having two layers.

FIG. 2 illustrates a cross-sectional view of a present multilayer article having three layers.

FIG. 3 illustrates a cross-sectional view of a present multilayer tube having two layers.

FIG. 4 illustrates a cross-sectional view of a present multilayer tube having three layers.

FIG. 5 illustrates a cross-sectional view of a present insulated wire having two layers.

FIG. 6 illustrates a cross-sectional view of a present insulated wire having three layers.

FIG. 7 illustrates a cross-sectional view of a present optical fiber having three layers.

FIG. 8 illustrates a cross-sectional view of a present optical fiber having three layers.

Skilled artisans appreciate that objects in the figures are illustrated for simplicity and clarity and have not been drawn to scale. The dimensions of some of the layers in the figures are exaggerated relative to other layers to help to improve understanding.

While the present invention will be described in connection with a number of embodiments thereof, it will be understood that the present invention is not intended to be limited to these embodiments. On the contrary, it is intended to cover all alternatives, modifications, and equivalents as may be included within the spirit and scope of the invention as defined by the appended claims.

### DETAILED DESCRIPTION

The detailed description addresses:

1. Definitions and Clarification of Terms;

2. Melt Processible Semicrystalline Fluoropolymer (FG-Fluoropolymer);

3. Hydrocarbon Monomer Having A Functional Group And A Polymerizable Carbon-Carbon Double Bond (FG);

4. FG-Fluoropolymer Comprising Repeating Units Arising From TFE and FG;

5. FG-Fluoropolymer Comprising Repeating Units Arising From TFE, HFP and FG;

6. FG-Fluoropolymer Comprising Repeating Units Arising From TFE, PAVE and FG;

7. FG-Fluoropolymer Comprising Repeating Units Arising From TFE, HFP, PAVE and FG;

8. FG-Fluoropolymer Melting Point And Melt Flow Rate;

9. FG-Fluoropolymer Fluorine Content;

10. FG-Fluoropolymer Fuel vapor transmission rate;

11. Optional Monomers;

12. Process For The Manufacture Of FG-Fluoropolymer;

13. FG-Fluoropolymer Utility; and Examples.

### 1. DEFINITIONS AND CLARIFICATION OF TERMS

Before addressing details of embodiments described below, some terms are defined or clarified.

By “semicrystalline” is meant that the melt processible semicrystalline fluoropolymers have some crystallinity and are characterized by a detectable melting point measured according to ASTM D 4501, and a melting endotherm of at least about 3 J/g. Semicrystalline fluoropolymers are distinguished from amorphous fluoropolymers.

By “melt processible” is meant that the polymer can be processed using conventional plastic processing techniques, such as melt extrusion.

Melt processible semicrystalline fluoropolymer described herein as comprising (a) about 0.001 to about 25 weight percent of repeating units arising from a hydrocarbon monomer having a functional group and a polymerizable carbon-carbon double bond, wherein the functional group is at least one selected from the group consisting of amine, amide, hydroxyl, phosphonate, sulfonate, nitrile, boronate and epoxide; and (b) the remaining weight percent of repeating units arising from tetrafluoroethylene, is alternately referred to herein as “FG-fluoropolymer.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which the claims belong. Although methods and materials similar or equivalent to those described herein can be used in the practice or testing of the embodiments disclosed, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

To the extent not described herein, many details regarding specific materials and processing acts are conventional and may be found in textbooks and other sources within the polymer art.

### 2. MELT PROCESSIBLE SEMICRYSTALLINE FLUOROPOLYMER (FG-FLUOROPOLYMER)

Described herein is a melt processible semicrystalline fluoropolymer comprising: (a) about 0.001 to about 25 weight percent of repeating units arising from a hydrocarbon monomer (FG) having a functional group and a polymerizable carbon-carbon double bond, wherein the functional group is at least one selected from the group consisting of amine, amide, hydroxyl, phosphonate, sulfonate, nitrile, boronate and epoxide; and (b) the remaining weight percent of repeating units arising from tetrafluoroethylene. This melt processible semicrystalline fluoropolymer is alternately referred to herein as “FG-fluoropolymer.”

In an embodiment, the FG-fluoropolymer comprises repeating units arising from TFE and FG. In another embodiment, the FG-fluoropolymer comprises repeating units arising from TFE, hexafluoropropylene (HFP) and FG. In another embodiment, the FG-fluoropolymer comprises repeating units arising from TFE, perfluoro(alkyl vinyl ether) (PAVE) and FG. In another embodiment, the FG-fluoropolymer comprises repeating units arising from TFE, HFP, PAVE and FG. In another embodiment, the FG-fluoropolymer comprises repeating units arising from TFE, FG and perfluoromonomer. Perfluoromonomer is defined herein as compounds containing the elements carbon and fluorine and carbon-carbon unsaturation. All monovalent atoms bonded to carbon in the perfluoromonomer are fluorine. In another embodiment, perfluoromonomer further contains at least one heteroatom selected from the group consisting of oxygen, sulfur and nitrogen.

Example perfluoromonomers include perfluoalkenes and perfluorinated vinyl ethers having 2 to 8 carbon atoms. In another embodiment perfluorinated vinyl ethers are represented by the formula CF₂═CFOR or CF₂═CFOR′OR, wherein R is perfluorinated linear or branched alkyl groups containing 1 to 5 carbon atoms, and R′ is perfluorinated linear or branched alkylene groups containing 1 to 5 carbon atoms. In another embodiment, R groups contain 1 to 4 carbon atoms. In another embodiment, R′ groups contain 2 to 4 carbon atoms.

Example perfluoromonomers include tetrafluoroethylene (TFE), hexafluoropropylene (HFP), perfluoro-2,2-dimethyl-1,3-dioxole (PDD), perfluoro-2-methylene-4-methyl-1,3-dioxolane (PMD), perfluoro-3,6-dioxa-4-methyl-7-octenesulfonyl fluoride (PSEPVE) and perfluoro(alkyl vinyl ethers) (PAVE) such as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE).

In another embodiment, FG-fluoropolymer comprises repeating units arising from a perfluoromonomer and a functional group monomer and is perfluorinated except for repeating units arising from the functional group monomer.

It has been discovered that the amount of repeating units arising from FG in the FG-fluoropolymer can be controlled to result in strong adhesion of the FG-perfluoropolymer to substrates such as metals, inorganics and functional group containing polymers, without leading to a decrease in the desirable fluoropolymer properties, such as chemical resistance and thermal stability.

Further, it has been discovered that the claimed amounts of repeating units in the present FG-fluoropolymer result in an FG-fluoropolymer that is melt processible and semicrystalline, and that can be processed by conventional plastic processing techniques, such as melt extrusion.

It has been discovered that in the embodiment where the FG-fluoropolymer comprises about 2 to about 20 weight percent of repeating units arising from HFP, the FG-fluoropolymer is melt processible and semicrystalline and has a surprisingly low melting point allowing for utility as a melt adhesive between higher melting point materials. It has been discovered that such low melting point semicrystalline FG-fluoropolymer can be produced without the use of substantial, or any, amounts of repeating units arising from the more expensive PAVE.

### 3. HYDROCARBON MONOMER HAVING A FUNCTIONAL GROUP AND A POLYMERIZABLE CARBON-CARBON DOUBLE BOND (FG)

Hydrocarbon monomer having a functional group and a polymerizable carbon-carbon double bond is alternately referred to herein as functional group monomer or FG. The polymerizable carbon-carbon double bond functions to allow repeating units arising from the functional group monomer to be incorporated into the fluoropolymer carbon-carbon chain backbone during polymerization. The functional group functions to increase the adhesion of a fluoropolymer with a given substrate with which it is in contact, for example, to result in strong adhesion between a layer of FG-fluoropolymer and a layer of polyamide. Polyamide and polymer containing fluorine but no FG normally have minimal to no adhesion one to the other. Functional groups of utility comprise at least one selected from the group consisting of amine, amide, hydroxyl, phosphonate, sulfonate, nitrile, boronate and epoxide. All monovalent atoms in the functional group monomer are hydrogen.

In another embodiment, FG contains an amine group and a polymerizable carbon-carbon double bond. Examples include aminoethyl acrylate, dimethylaminoethyl methacrylate, dimethylaminoethyl acrylate, aminoethyl vinyl ether, dimethylaminoethyl vinyl ether and vinyl aminoacetate.

In another embodiment, FG contains an amide group and a polymerizable carbon-carbon double bond. Examples include N-methyl-N-vinyl acetamide, acrylamide and N-vinylformamide.

In another embodiment, FG contains an hydroxyl group and a polymerizable carbon-carbon double bond. Examples include 2-hydroxyethyl vinyl ether and omega-hydroxybutyl vinyl ether.

In another embodiment, FG contains a phosphonate group and a polymerizable carbon-carbon double bond. An example is diethylvinyl phosphonate.

In another embodiment, FG contains a sulfonate group and a polymerizable carbon-carbon double bond. An example is ammonium vinyl sulfonate.

In another embodiment, FG contains a nitrile group and a polymerizable carbon-carbon double bond. An example is acrylonitrile.

In another embodiment, FG contains a boronate group and a polymerizable carbon-carbon double bond. Examples include vinyl boronic acid dibutyl ester, 4-vinyl phenyl boronic acid and 4-bentenyl boronic acid.

In another embodiment, FG contains an epoxide group and a polymerizable carbon-carbon double bond. An example is allyl glycidal ether (AGE).

In another embodiment, FG-fluoropolymer comprises about 0.001 to about 25 weight percent of repeating units arising from FG. In another embodiment, FG-fluoropolymer comprises about 0.001 to about 20 weight percent of repeating units arising from FG. In another embodiment, FG-fluoropolymer comprises about 0.001 to about 15 weight percent of repeating units arising from FG. In another embodiment, FG-fluoropolymer comprises about 0.001 to about 10 weight percent of repeating units arising from FG. In another embodiment, FG-fluoropolymer comprises about 0.001 to about 5 weight percent of repeating units arising from FG. In another embodiment, FG-fluoropolymer comprises about 0.001 to about 2 weight percent of repeating units arising from FG. In another embodiment, FG-fluoropolymer comprises about 0.001 to about 1 weight percent of repeating units arising from FG. In another embodiment, FG-fluoropolymer comprises about 0.001 to about 0.5 weight percent of repeating units arising from FG. In another embodiment, FG-fluoropolymer comprises about 0.001 to about 0.3 weight percent of repeating units arising from FG. In another embodiment, FG-fluoropolymer comprises about 0.001 to about 0.1 weight percent of repeating units arising from FG. In another embodiment, FG-fluoropolymer comprises about 0.001 to about 0.01 weight percent of repeating units arising from FG. In another embodiment, FG-fluoropolymer comprises about 0.01 to about 2 weight percent of repeating units arising from FG. In another embodiment, FG-fluoropolymer comprises about 0.01 to about 1 weight percent of repeating units arising from FG. In another embodiment, FG-fluoropolymer comprises about 0.01 to about 0.5 weight percent of repeating units arising from FG. In another embodiment, FG-fluoropolymer comprises about 0.03 to about 0.3 weight percent of repeating units arising from FG. The weight percent of repeating units arising from FG referred to here is relative to the sum of the weight of repeating units arising from FG and tetrafluoroethylene repeating units in the FG-fluoropolymer.

### 4. FG-FLUOROPOLYMER COMPRISING REPEATING UNITS ARISING FROM TETRAFLUOROETHYLENE AND FG

In another embodiment, FG-fluoropolymer comprises repeating units arising from TFE and FG.

In another embodiment, the melt processible semicrystalline fluoropolymer comprises: (a) about 0.001 to about 25 weight percent of repeating units arising from a hydrocarbon monomer having a functional group and a polymerizable carbon-carbon double bond, wherein said functional group is at least one selected from the group consisting of amine, amide, hydroxyl, phosphonate, sulfonate, nitrile, boronate and epoxide; and (b) the remaining weight percent of repeating units arising from tetrafluoroethylene.

In another embodiment, the melt processible semicrystalline fluoropolymer comprises (a) about 0.001 to about 25 weight percent of repeating units arising from a hydrocarbon monomer having a functional group and a polymerizable carbon-carbon double bond, wherein said functional group is at least one selected from the group consisting of amine, amide, hydroxyl, phosphonate, sulfonate, nitrile, boronate and epoxide; and (b) the remaining weight percent of repeating units arising from tetrafluoroethylene; wherein said melt processible semicrystalline fluoropolymer has a melting point below about 265° C. and a fluorine content of at least about 69 weight percent.

### 5. FG-FLUOROPOLYMER COMPRISING REPEATING UNITS ARISING FROM TFE, HFP AND FG

In another embodiment, FG-fluoropolymer comprises repeating units arising from TFE, HFP and FG.

In another embodiment, melt processible semicrystalline fluoropolymer comprises; (a) about 0.001 to about 25 weight percent of repeating units arising from FG; (b) about 2 to about 20 weight percent of repeating units arising from HFP; and (c) the remaining weight percent of repeating units arising from TFE.

In another embodiment, the FG-fluoropolymer comprising TFE, HFP and FG comprises about 4 to about 20 weight percent of repeating units arising from HFP. In another embodiment, the FG-fluoropolymer comprising TFE, HFP and FG comprises about 9 to about 14 weight percent of repeating units arising from HFP. In another embodiment, the FG-fluoropolymer comprising TFE, HFP and FG comprises about 4 to about 14 weight percent of repeating units arising from HFP. In another embodiment, the FG-fluoropolymer comprising TFE, HFP and FG comprises about 10 to about 12 weight percent of repeating units arising from HFP.

Various embodiments of the amount of repeating units arising from FG in the FG-fluoropolymer comprising TFE, HFP and FG are contemplated, and are described earlier herein in the section titled “3. Hydrocarbon monomer Having a Functional Group and a Polymerizable Carbon-Carbon Double Bond (FG).”

### 6. FG-FLUOROPOLYMER COMPRISING REPEATING UNITS ARISING FROM TFE, PAVE AND FG

In another embodiment, FG-fluoropolymer comprises repeating units arising from TFE, PAVE, and FG.

In another embodiment, melt processible semicrystalline fluoropolymer comprises; (a) about 0.001 to about 25 weight percent of repeating units arising from FG; (b) about 2 to about 20 weight percent of repeating units arising from PAVE; and (c) the remaining weight percent of repeating units arising from TFE.

In another embodiment, the FG-fluoropolymer comprising TFE, PAVE and FG comprises about 2 to about 18 weight percent of repeating units arising from PAVE. In another embodiment, the FG-fluoropolymer comprising TFE, PAVE and FG comprises about 3 to about 18 weight percent of repeating units arising from PAVE. In another embodiment, the FG-fluoropolymer comprising TFE, PAVE and FG comprises about 7 to about 18 weight percent of repeating units arising from PAVE. In another embodiment, the FG-fluoropolymer comprising TFE, PAVE and FG comprises about 9 to about 15 weight percent of repeating units arising from PAVE.

Various embodiments of the amount of repeating units arising from FG in the FG-fluoropolymer comprising TFE, PAVE and FG are contemplated, and are described earlier herein in the section titled “3. Hydrocarbon monomer Having a Functional Group and a Polymerizable Carbon-Carbon Double Bond (FG).”

### 7. FG-FLUOROPOLYMER COMPRISING REPEATING UNITS ARISING FROM TFE, HFP, PAVE AND FG

In another embodiment, FG-fluoropolymer comprises repeating units arising from TFE, HFP, PAVE, and FG.

In another embodiment, FG-fluoropolymer comprises: (a) about 0.001 to about 10 weight percent of repeating units arising from FG; (b) about 2 to about 20 weight percent of repeating units arising from HFP; (c) about 0.5 to about 10 weight percent of repeating units arising from PAVE; and (d) the remaining weight percent of repeating units arising from TFE; wherein the sum of the weight percent of repeating units arising from HFP and PAVE is about 4 to about 20 weight percent.

In another embodiment, the FG-fluoropolymer comprising TFE, HFP, PAVE and FG comprises about 4 to about 20 weight percent of repeating units arising from HFP. In another embodiment, the FG-fluoropolymer comprising TFE, HFP, PAVE and FG comprises about 4 to about 16 weight percent of repeating units arising from HFP. In another embodiment, the FG-fluoropolymer comprising TFE, HFP, PAVE and FG comprises about 8 to about 16 weight percent of repeating units arising from HFP. In another embodiment, the FG-fluoropolymer comprising TFE, HFP, PAVE and FG comprises about 9 to about 14 weight percent of repeating units arising from HFP.

In another embodiment, the FG-fluoropolymer comprising TFE, HFP, PAVE and FG comprises about 1 to about 10 weight percent of repeating units arising from PAVE. In another embodiment, the FG-fluoropolymer comprising TFE, HFP, PAVE and FG comprises about 2 to about 8 weight percent of repeating units arising from PAVE. In another embodiment, the FG-fluoropolymer comprising TFE, HFP, PAVE and FG comprises about 3 to about 7 weight percent of repeating units arising from PAVE.

Various embodiments of the amount of repeating units arising from FG in the TFE/HFP/PAVE/FG FG-fluoropolymer are contemplated, and are described earlier herein in the section titled “3. Hydrocarbon monomer Having a Functional Group and a Polymerizable Carbon-Carbon Double Bond (FG).”

In another embodiment, the FG-fluoropolymer comprising TFE, HFP, PAVE and FG comprises: (a) about 0.01 to about 0.1 weight percent of repeating units arising from FG; (b) about 12 weight percent of repeating units arising from HFP; (c) about 0.75 weight percent of repeating units arising from PAVE; and (d) the remaining weight percent of repeating units arising from TFE.

In another embodiment, the FG-fluoropolymer comprising TFE, HFP, PAVE and FG comprises: (a) about 0.01 to about 0.1 weight percent of repeating units arising from FG; (b) about 12 weight percent of repeating units arising from HFP; (c) about 1.5 weight percent of repeating units arising from PAVE; and (d) the remaining weight percent of repeating units arising from TFE. In another embodiment, the FG-fluoropolymer comprising TFE, HFP, PAVE and FG comprises: (a) about 0.01 to about 0.1 weight percent of repeating units arising from FG; (b) about 6 weight percent of repeating units arising from HFP; (c) about 2 weight percent of repeating units arising from PAVE; and (d) the remaining weight percent of repeating units arising from TFE.

In another embodiment, the FG-fluoropolymer comprising TFE, HFP, PAVE and FG comprises: (a) about 0.01 to about 0.1 weight percent of repeating units arising from FG; (b) about 5 weight percent of repeating units arising from HFP; (c) about 5 weight percent of repeating units arising from PAVE; and (d) the remaining weight percent of repeating units arising from TFE.

In another embodiment, the FG-fluoropolymer comprising TFE, HFP, PAVE and FG comprises: (a) about 0.01 to about 0.1 weight percent of repeating units arising from FG; (b) about 5 to about 6 weight percent of repeating units arising from HFP; (c) about 6 to about 7 weight percent of repeating units arising from perfluoro(methyl vinyl ether); and (d) about 86 to about 87 weight percent of repeating units arising from TFE.

### 8. FG-FLUOROPOLYMER MELTING POINT AND MELT FLOW RATE

FG-fluoropolymer melting point can be determined by ASTM method D 4591-01, “Standard Test Method for Determining Temperatures and Heats of Transitions of Fluoropolymers by Differential Scanning Calorimetry.”

In another embodiment the melting point of the FG-fluoropolymer is below about 265° C. In another embodiment the melting point of the FG-fluoropolymer is below about 260° C. In another embodiment the melting point of the FG-fluoropolymer is below about 250° C. In another embodiment the melting point of the FG-fluoropolymer is below about 240° C. In another embodiment the melting point of the FG-fluoropolymer is below about 230° C. In another embodiment the melting point of the FG-fluoropolymer is below about 225° C. In another embodiment the melting point of the FG-fluoropolymer is below about 220° C.

FG-fluoropolymer melt flow rate (MFR) can be determined by ASTM method D1238-04c. The present process has the capability of producing an FG-fluoropolymer of a desired MFR for a specific utility, e.g., an FG-fluoropolymer MFR substantially similar to the MFR of another polymer that the FG-fluoropolymer is to be coextruded with.

In one embodiment, MFR of FG-fluoropolymer produced by the present process is about 1 to about 400 g/10 minutes. In another embodiment, MFR of FG-fluoropolymer produced by the present process is about 10 to about 300 g/10 minutes. In another embodiment, MFR of FG-fluoropolymer produced by the present process is about 1 to about 10 g/10 minutes. In another embodiment, MFR of FG-fluoropolymer produced by the present process is about 20 to about 90 g/10 minutes. In another embodiment, MFR of FG-fluoropolymer produced by the present process is about 1 to about 50 g/10 minutes. In another embodiment, MFR of FG-fluoropolymer produced by the present process is about 5 to about 40 g/10 minutes. In another embodiment, MFR of FG-fluoropolymer produced by the present process is about 10 to about 30 g/10 minutes. In another embodiment, MFR of FG-fluoropolymer produced by the present process is about 15 to about 30 g/10 minute. In another embodiment, MFR of FG-fluoropolymer produced by the present process is about 20 to about 30 g/10 minutes.

### 9. FG-FLUOROPOLYMER FLUORINE CONTENT

FG-fluoropolymer fluorine content can be determined by mass balance based on the amount of monomer consumed in the polymerization process used to make the FG-fluoropolymer.

In another embodiment, FG-fluoropolymer fluorine content is at least about 65 weight percent. In another embodiment, FG-fluoropolymer fluorine content is at least about 70 weight percent. In another embodiment, FG-fluoropolymer fluorine content is at least about 75 weight percent.

### 10. FG-FLUOROPOLYMER FUEL PERMEATION COEFFICIENT

FG-fluoropolymer resists permeation by liquid fuels and liquid petroleum products such as gasoline, CE10 (mixture of 10 volume percent ethanol and the remainder gasoline), CE85 (mixture of 85 volume percent ethanol and the remainder gasoline), diesel fuel, heating oil, biofuel, and biodiesel. FG-fluoropolymer also resists permeation by industrial solvents such as alcohols, ketones, and esters.

In an embodiment, the CE10 fuel vapor transmission rate at 40° C. as measured by the procedure described in SAE J2659-03 is not greater than about 0.1 g·mm/m²·day. In another embodiment, the CE10 fuel vapor transmission rate at 40° C. as measured by the procedure described in SAE J2659-03 is not greater than about 0.05 g·mm/m²·day. In another embodiment, the CE10 fuel vapor transmission rate at 40° C. as measured by the procedure described in SAE J2659-03 is not greater than about 0.04 g·mm/m²·day.

### 11. OPTIONAL MONOMERS

In another embodiment, FG-fluoropolymer optionally contains repeating units arising from a non-perfluorinated monomer such as ethylene, propylene, vinylidene fluoride, vinyl fluoride, chlorotrifluoroethylene and methyl perfluoro-4,7-dioxa-5-methyl-8-nonenoate (EVE). If repeating units arising from such non-perfluorinated monomers are present in the FG-fluoropolymer, they are present at a low level that does not reduce the beneficial properties of the FG-fluoropolymer, such as adhesion and fuel permeation resistance properties of the FG-fluoropolymer.

In another embodiment, the FG-fluoropolymer contains about 0.1 to about 5 weight percent of repeating units arising non-perfluorinated monomers other than FG.

In another embodiment, the FG-fluoropolymer contains about 1 weight percent or less of repeating units arising non-perfluorinated monomers other than FG.

### 12. PROCESS FOR THE MANUFACTURE OF FG-FLUOROPOLYMER

In another embodiment, FG-fluoropolymer can be manufactured by adaptation of known processes, such as polymerization in supercritical carbon dioxide as disclosed in U.S. Pat. No. 6,107,423.

In another embodiment, FG-fluoropolymer can be manufactured by an aqueous dispersion polymerization process such as described in the present preparative examples.

### 13. FG-FLUOROPOLYMER UTILITY

FG-fluoropolymer has utility as adhesive for adhering perfluoropolymer (e.g., PTFE, FEP, PFA) and polymer, metal or inorganic substrates. Perfluoropolymer strongly adheres to FG-fluoropolymer, and FG-fluoropolymer strongly adheres to many polymers, metals and inorganics.

In another embodiment, a substrate contains polar functionality (e.g., amine) that react with, or otherwise strongly associates with, the functional groups of the FG-fluoropolymer, resulting in strong adhesion between the FG-fluoropolymer and such a substrate.

In another embodiment, FG-fluoropolymer aqueous dispersion can be blended with another polymer aqueous dispersion, then the dispersion blended polymer isolated and used, for example, as adhesive. In another embodiment, FG-fluoropolymer can be melt blended with another polymer, and the resultant melt blend used, for example, as adhesive.

In another embodiment, FG-fluoropolymer is coextruded as an adhesive layer between two other polymer layers to be adhered.

The use of FG-fluoropolymer as adhesive can be accomplished as is known in the art for other kinds of polymers which accomplish the same end using similar methods. For instance, melt mixing of polymers using equipment such as screw extruders is known. Similarly multilayer film extrusion, including the use of adhesive or tie layers is also known.

13.1 Multilayer Article Comprising FG-Fluoropolymer

In another embodiment, FG-fluoropolymer finds utility in a multilayer article comprising: (A) a first layer comprising a substrate; and (B) a second layer comprising FG-fluoropolymer, wherein (A) and (B) are in contiguous contact.

In another embodiment, the substrate contains polar functionality that associates or bonds with the functional group of the hydrocarbon monomer having a functional group and a polymerizable carbon-carbon double bond.

In another embodiment, the substrate is selected from the group consisting of non-fluorinated polymer having polar functionality, metal and inorganic. In another embodiment, the substrate is a non-fluorinated polymer having polar functionality, wherein the polar functionality is selected from the group consisting of amine, amide, imide, nitrile, urethane, chloride, ether, ester, hydroxyl, carbonate, and carboxyl.

In another embodiment, substrate is at least one selected from the group consisting of: ethylene-ethyl acrylate; ethylene-methyl acrylate; polyethylene-vinyl alcohol copolymers; polyamide; polyethylene terephthalate; polyimide; polymethyl methacrylate; polyvinyl acetate; polyvinyl alcohol, polycarbonate, polyvinyl butyral, polyurethane, polyacrylonitrile, and polyvinyl chloride. In another embodiment, the substrate comprises a thermoplastic polyamide having a relative viscosity of about 50 or less, and about 10 or greater meq amine ends per kg of said thermoplastic polyamide. In another embodiment, the substrate is a non-fluorinated polymer having polar functionality, and delamination of the multilayer article does not occur below the yield strength of the first layer (A) and/or the second layer (B).

In another embodiment, the substrate comprises a metal. In another embodiment, the metal is selected from the group consisting of aluminum, chromium, cobalt, copper, iron, manganese, molybdenum, nickel, niobium, rhenium, steel, tantalum, titanium, tungsten, and zirconium. In another embodiment where the substrate is metal, delamination of the multilayer article does not occur below the yield strength of the second layer (B).

In another embodiment, the substrate comprises an inorganic selected from the group consisting of silicates, carbonates, sulfates, halides, oxides and sulfides.

In another embodiment, the multilayer article further comprises a third layer (B1) comprising perfluoropolymer, wherein the third layer (B1) is in contiguous contact with the second layer (B).

In another embodiment, the multilayer article is manufactured by a process comprising lamination of the first layer (A) and the second layer (B).

In another embodiment, the multilayer article is manufactured by a process comprising vapor depositing the first layer (A) on to the second layer (B).

In another embodiment, the multilayer article is manufactured by a process comprising electrostatically powder coating the melt processible fluoropolymer onto the first layer (A) to form a powder coated first layer (A), and heating the powder coated first layer (A) form the multilayer article.

In another embodiment, the multilayer article can be manufactured by a process comprising powder dispersed liquid coating the melt processible fluoropolymer onto the first layer (A) to form a powder dispersed liquid coated first layer (A), and heating the powder dispersed liquid coated first layer (A) to form the multilayer article. A known process of powder dispersed liquid coating can be used, in this embodiment, such as that disclosed in EP Patent No. 0789728 B1 to Hagiwara et al.

In another embodiment, the multilayer article can be manufactured by a process comprising aqueous dispersion coating the melt processible fluoropolymer onto the first layer (A) to form an aqueous dispersion coated first layer (A), and heating the aqueous dispersion coated first layer (A) to form the multilayer article. A known process of aqueous dispersion coating can be used, in this embodiment, such as that disclosed in U.S. Pat. No. 3,925,292 to Holmes.

In another embodiment, the multilayer article can be manufactured by a process comprising rotolining the melt processible fluoropolymer onto the first layer (A) to form a rotolined coated first layer (A), and heating the rotolined first layer (A) to form the multilayer article. A known rotolining process can be used in this embodiment, such as that disclosed in U.S. Pat. No. 6,287,632 to Nishio et al.

In another embodiment, the multilayer article is a laminate comprising at least two layers.

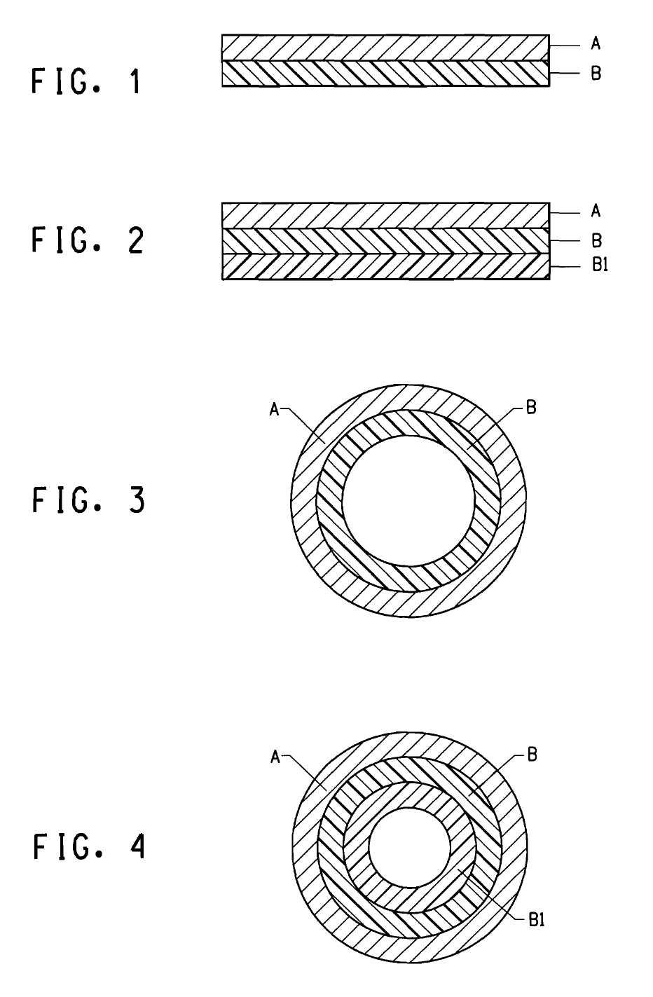

FIG. 1 illustrates a cross-sectional view of one embodiment of the present invention being a multilayer article having two layers comprising: (A) a first layer comprising a substrate; and (B) a second layer comprising FG-fluoropolymer. One face of the second layer (B) is in contiguous contact with one face of the first layer (A).

FIG. 2 illustrates a cross-sectional view of one embodiment of the present invention being a multilayer article having three layers comprising: (A) a first layer comprising a substrate; (B) a second layer comprising FG-fluoropolymer; and (B1) a third layer comprising perfluoropolymer. One face of third layer (B1) is in contiguous contact with a first face of the second layer (B), and one face of the first layer (A) is in contiguous contact with a second face of the second layer (B).

13.2 Multilayer Tubing Comprising FG-Fluoropolymer

In another embodiment, FG-fluoropolymer can be used to adhere perfluoropolymer and thermoplastic having amine functionality in an article such as a perfluoropolymer-lined polyamide tube of utility for petroleum fuel service. In order to form such an article, a layer of FG-fluoropolymer can be melt extruded as an interlayer between a melt extruded layer of perfluoropolymer and a melt extruded layer of polyamide.

In another embodiment, FG-fluoropolymer finds utility in a multilayer tube comprising: (A) a first layer comprising a non-fluorinated polymer having polar functionality; and (B) a second layer comprising FG-fluoropolymer; wherein the layers are arranged concentrically such that the first layer (A) is outside of the second layer (B), and the outer face of the second layer (B) is in contiguous contact with the inner face of the first layer (A).

FIG. 3 illustrates a cross-sectional view of one embodiment of the present invention being a multilayer tube having two layers comprising: a first layer (A) comprising a non-fluorinated polymer having polar functionality, and; a second layer (B) comprising FG-fluoropolymer; wherein the layers are arranged concentrically such that first layer (A) is outside of second layer (B). The outer face of second layer (B) is in contiguous contact with the inner face of first layer (A).

FIG. 4 illustrates a cross-sectional view of one embodiment of the present invention being a multilayer tube having three layers comprising: a first layer (A) comprising a non-fluorinated polymer having polar functionality; a second layer (B) comprising FG-fluoropolymer; and a third layer (B1) comprising a perfluoropolymer; wherein the layers are arranged concentrically such that second layer (B) is outside of third layer (B1) and first layer (A) is outside of second layer (B). The outer face of third layer (B1) is in contiguous contact with the inner face of second layer (B), and the outer face of second layer (B) is in contiguous contact with the inner face of first layer (A).

13.3 Insulated Wire Comprising FG-Fluoropolymer

In another embodiment, FG-fluoropolymer finds utility in an insulated wire comprising: (A) a wire comprising metal; and (B) a layer comprising FG-fluoropolymer; wherein (A) and (B) are in contiguous contact.

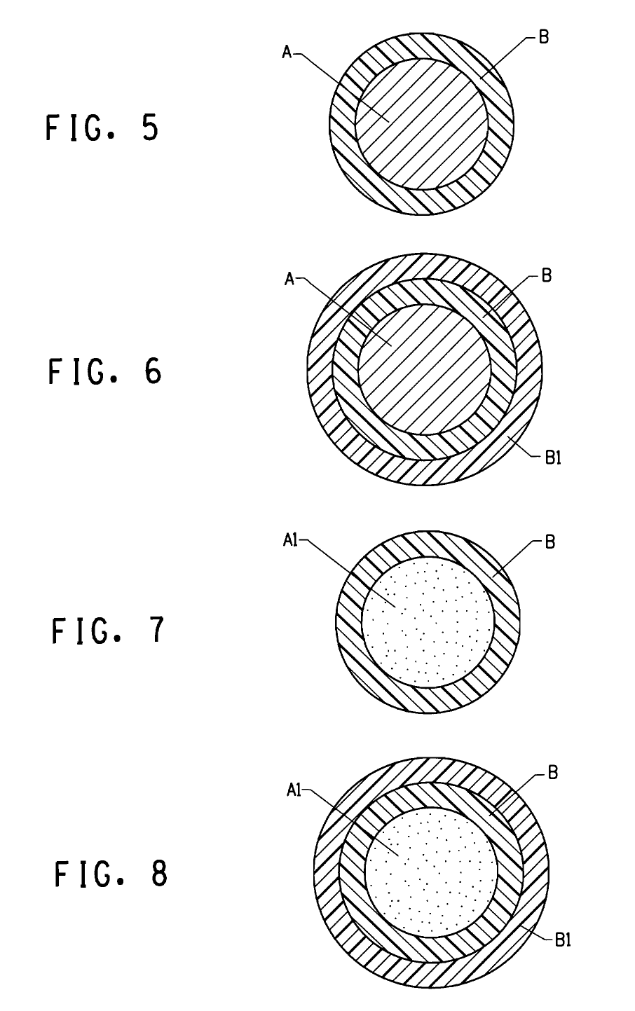

FIG. 5 illustrates a cross-sectional view of one embodiment of the present invention being an insulated wire having two layers comprising: a wire (A) comprising metal, and; a second layer (B) comprising FG-fluoropolymer; wherein the second layer (B) is arranged concentrically outside of the wire (A). The inner face of the second layer (B) is in contiguous contact with the face of the wire (A).

FIG. 6 illustrates a cross-sectional view of one embodiment of the present invention being an insulated wire having three layers comprising: a wire (A) comprising metal; a second layer (B) comprising FG-fluoropolymer, and; a third layer (B1) comprising perfluoropolymer; wherein the layers are arranged concentrically such that the second layer (B) is outside of the wire (A) and the third layer (B1) is outside of the second layer (B). The inner face of the third layer (B1) is in contiguous contact with the outer face of the second layer (B), and the inner face of the second layer (B) is in contiguous contact with the face of the wire (A).

13.4 Melt Extrusion Die Coated with FG-Fluoropolymer

In another embodiment, FG-fluoropolymer finds utility in a melt extrusion die having a flow passage coated with a composition comprising FG-fluoropolymer. In another embodiment, FG-fluoropolymer finds utility in a process for melt extruding a polymer, comprising: (A) coating the flow passage of a melt extrusion die with FG-fluoropolymer to form a coated melt extrusion die; and (B) melt extruding a polymer through the coated melt extrusion die.

13.5 Optical Fiber Comprising FG-Fluoropolymer

In another embodiment, FG-fluoropolymer finds utility in an optical fiber comprising: (A) a fiber comprising an inorganic substrate; and (B) a layer comprising FG-fluoropolymer; wherein (A) and (B) are in contiguous contact.

FIG. 7 illustrates a cross-sectional view of one embodiment of the present invention being an optical fiber having two layers comprising: a fiber (A1) comprising an inorganic substrate, and; a second layer (B) comprising FG-fluoropolymer; wherein the second layer (B) is arranged concentrically outside of the fiber (A1). The inner face of the second layer (B) is in contiguous contact with the face of the fiber (A1).

FIG. 8 illustrates a cross-sectional view of one embodiment of the present invention being an optical fiber having three layers comprising: a fiber (A1) comprising an inorganic substrate; a second layer (B) comprising FG-fluoropolymer; and a third layer (B1) comprising perfluoropolymer; wherein the layers are arranged concentrically such that the second layer (B) is outside of the fiber (A1) and the third layer (B1) is outside of the second layer (B). The inner face of the third layer (B1) is in contiguous contact with the outer face of the second layer (B), and the inner face of the second layer (B) is in contiguous contact with the face of the fiber (A1).

The embodiments described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims.

### Methods

MFR: Melt flow rate (MFR) is measured by ASTM method D1238-04c, modified as follows: The cylinder, orifice and piston tip are made of a corrosion-resistant alloy, Haynes Stellite 19, made by Haynes Stellite Co. The 5.0 g sample is charged to the 9.53 mm (0.375 inch) inside diameter cylinder, which is maintained at 372±1° C. Five minutes after the sample is charged to the cylinder, it is extruded through a 2.10 mm (0.0825 inch) diameter, 8.00 mm (0.315 inch) long square-edge orifice under a load (piston plus weight) of 5000 grams.

### Example 1

### FG-Fluoropolymer: TFE/PEVE/Allyl Glycidyl Ether

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 15.4 grams dibasic ammonium phosphate, 17.5 grams monobasic ammonium phosphate, 580 mL of a 20 wt % solution of ammonium perfluoro-2-propoxypropionate surfactant in water, and 4.5 grams of Krytox® 157 FSL perfluoropolymer carboxylic acid. With the reactor paddle agitated at 50 rpm, the reactor was heated to 25° C., evacuated and purged three times with tetrafluoroethylene (TFE). The reactor was then charged with ethane to 8 inches Hg (27 KPa). The reactor temperature then was decreased to 75° C. Then 400 mL of liquid perfluoro(ethylvinyl ether) (PEVE) was injected into the reactor. Then TFE was added to the reactor to achieve a final pressure of 200 psig (1.48 MPa). Then 400 mL of freshly prepared aqueous initiator solution containing 1.83 wt % ammonium persulfate (APS) was charged into the reactor. Then, this same initiator solution was pumped into the reactor at 2 mL/min for the remainder of the polymerization. After polymerization had begun as indicated by a 10 psi (70 KPa) drop in reactor pressure, additional TFE was added to the reactor at a rate of 12 pounds (5.4 kg)/120 minutes. Furthermore, liquid PEVE was added at a rate of 5.0 mL/min for the duration of the reaction. After 1 pound (0.45 kg) of TFE had been fed after kickoff, an aqueous solution of 1 wt % allyl glycidyl ether was started at 5 mL/minute and continued for the remainder of the batch. After 12 pounds (5.4 kg) of TFE had been injected over a reaction period of 120 minutes, the reaction was terminated. At the end of the reaction period, the TFE, PEVE, initiator solution and allyl glycidyl ether solution feeds were stopped, and the reactor was slowly vented. After venting to nearly atmospheric pressure, the reactor was purged with nitrogen to remove residual monomer. Upon further cooling, the dispersion was discharged from the reactor at below 60° C. After coagulation, the polymer was isolated by filtering and then drying in a 150° C. convection air oven. The polymer had a melt flow rate of 12.2 g/10 min, a melting point of 244° C., a PEVE content of 15.1 wt %, and an allyl glycidyl ether content of 0.088 wt %.

### Example 2

### FG-Fluoropolymer: TFE/HFP/PEVE/Hydroxybutyl Vinyl Ether

A cylindrical, horizontal, water-jacketed, paddle-stirred, stainless steel reactor having a length to diameter ratio of about 1.5 and a water capacity of 10 gallons (37.9 L) was charged with 50 pounds (22.7 kg) of demineralized water, 330 mL of a 20 wt % solution of ammonium perfluorooctanoate surfactant in water, and 5.9 grams of Krytox® 157 FSL perfluoropolymer carboxylic acid. With the reactor paddle agitated at 46 rpm, the reactor was heated to 60° C., evacuated and purged three times with tetrafluoroethylene (TFE). The reactor temperature then was decreased to 103° C. After the temperature had become steady at 103° C., HFP was added slowly to the reactor until the pressure was 444 psig (3.16 MPa). Then 92 mL of liquid PEVE was injected into the reactor. Then TFE was added to the reactor to achieve a final pressure of 645 psig (4.55 MPa). Then 40 mL of freshly prepared aqueous initiator solution containing 1.83 wt % ammonium persulfate (APS) was charged into the reactor. Then, this same initiator solution was pumped into the reactor at 10 mL/min for the remainder of the polymerization. After polymerization had begun as indicated by a 10 psi (70 KPa) drop in reactor pressure, additional TFE was added to the reactor at a rate of 24.5 pounds (11.1 kg)/125 minutes. Furthermore, liquid PEVE was added at a rate of 1.0 mL/min for the duration of the reaction. After 1 pound (0.45 kg) of TFE had been fed after kickoff, hydroxybutyl vinyl ether (HBVE, density 0.939 g/mL) was injected at a rate of 0.05 mL/min for 110 minutes. At this point, approximately 10 minutes before the end of the batch, the PEVE feed was also stopped. After 24.5 pounds (11.1 kg) of TFE had been injected over a reaction period of 125 minutes, the reaction was terminated. At the end of the reaction period, the TFE and initiator solution feeds were stopped, and the reactor was cooled while maintaining agitation. When the temperature of the reactor contents reached 90° C., the reactor was slowly vented. After venting to nearly atmospheric pressure, the reactor was purged with nitrogen to remove residual monomer. Upon further cooling, the dispersion was discharged from the reactor at below 70° C. After coagulation, the polymer was isolated by filtering and then drying in a 150° C. convection air oven. The polymer had a melt flow rate of 100 g/10 min, a melting point of 228° C., an HFP content of 13.57 wt %, a PEVE content of 1.36 wt %, and an HBVE content of 0.040 wt %.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges include each and every value within that range.

What is claimed is:

1. A melt processible semicrystalline fluoropolymer comprising:
(a) about 0.001 to about 25 weight percent of repeating units arising from a hydrocarbon monomer having a functional group and a polymerizable carbon-carbon double bond, wherein said functional group is at least one selected from the group consisting of amine, amide, hydroxyl, phosphonate, sulfonate, nitrile, boronate and epoxide; and
(b) the remaining weight percent of repeating units arising from tetrafluoroethylene.

2. The melt processible semicrystalline fluoropolymer of claim 1, further comprising:
(c) about 2 to about 20 weight percent of repeating units arising from hexafluoropropylene.

3. The melt processible semicrystalline fluoropolymer of claim 1, further comprising:
(c) about 2 to about 20 weight percent of repeating units arising from perfluoro(alkyl vinyl ether).

4. The melt processible semicrystalline fluoropolymer of claim 1, further comprising:
(c) about 2 to about 20 weight percent of repeating units arising from hexafluoropropylene; and
(d) about 0.5 to about 10 weight percent of repeating units arising from perfluoro(alkyl vinyl ether); wherein the sum of the weight percent of repeating units arising from hexafluoropropylene and perfluoro(alkyl vinyl ether) is about 4 to about 20 weight percent.

5. The melt processible semicrystalline fluoropolymer of claim 1, having a CE10 fuel vapor transmission rate at 40° C. as measured by the procedure described in SAE J2659-03 of not greater than about 0.1 g·mm/m²·day.

6. A multilayer article comprising:
(A) a first layer comprising a substrate; and
(B) a second layer comprising said melt processible semicrystalline fluoropolymer of claim 1; wherein (A) and (B) are in contiguous contact.

7. The multilayer article of claim 6, wherein said substrate contains polar functionality that associates or bonds with the functional group of said hydrocarbon monomer having a functional group and a polymerizable carbon-carbon double bond.

8. The multilayer article of claim 6, wherein said substrate is selected from the group consisting of non-fluorinated polymer having polar functionality, metal and inorganic.

9. The multilayer article of claim 6, wherein said substrate is a non-fluorinated polymer having polar functionality, wherein said polar functionality is selected from the group consisting of amine, amide, imide, nitrile, urethane, chloride, ether, ester, hydroxyl, carbonate, and carboxyl.

10. The multilayer article of claim 6, wherein said substrate is at least one selected from the group consisting of: ethylene-ethyl acrylate; ethylene-methyl acrylate; polyethylene-vinyl alcohol copolymers; polyamide; polyethylene terephthalate; polyimide; polymethyl methacrylate; polyvinyl acetate; polyvinyl alcohol, polycarbonate, polyvinyl butyral, polyurethane, polyacrylonitrile, and polyvinyl chloride.

11. The multilayer article of claim 6, wherein said substrate comprises a thermoplastic polyamide having a relative viscosity of about 50 or less, and about 10 or greater meq amine ends per kg of said thermoplastic polyamide.

12. The multilayer article of claim 6, wherein said substrate is a non-fluorinated polymer having polar functionality, and wherein delamination does not occur below the yield strength of said first layer (A) and/or said second layer (B).

13. The multilayer article of claim 6, wherein said substrate comprises a metal.

14. The multilayer article of claim 13, wherein said metal is selected from the group consisting of aluminum, chromium, cobalt, copper, iron, manganese, molybdenum, nickel, niobium, rhenium, steel, tantalum, titanium, tungsten, and zirconium.

15. The multilayer article of claim 13, wherein delamination does not occur below the yield strength of said second layer (B).

16. The multilayer article of claim 6, wherein said substrate comprises an inorganic selected from the group consisting of silicates, carbonates, sulfates, halides, oxides and sulfides.

17. The multilayer article of claim 6, further comprising a third layer (B1) comprising perfluoropolymer, wherein said third layer (B1) is in contiguous contact with said second layer (B).

18. The multilayer article of claim 6, wherein said multilayer article is manufactured by a process comprising lamination of said first layer (A) and said second layer (B).

19. The multilayer article of claim 6, wherein said multilayer article is manufactured by a process comprising vapor depositing said first layer (A) on to said second layer (B).

20. The multilayer article of claim 6, wherein said multilayer article is manufactured by a process comprising electrostatically powder coating said melt processible fluoropolymer onto said first layer (A) to form a powder coated first layer (A), and heating said powder coated first layer (A) to form said multilayer article.

21. The multilayer article of claim 6, wherein said multilayer article is manufactured by a process comprising powder dispersed liquid coating said melt processible fluoropolymer onto said first layer (A) to form a powder dispersed liquid coated first layer (A), and heating said powder dispersed liquid coated first layer (A) to form said multilayer article.

22. The multilayer article of claim 6, wherein said multilayer article is manufactured by a process comprising aqueous dispersion coating said melt processible fluoropolymer onto said first layer (A) to form aqueous dispersion coated first layer (A), and heating said powder dispersed liquid coated first layer (A) to form said multilayer article.

23. The multilayer article of claim 6, wherein said multilayer article is manufactured by a process comprising rotolining said melt processible fluoropolymer onto said first layer (A) to form a rotolined coated first layer (A), and heating said rotolined coated first layer (A) to form said multilayer article.

24. A multilayer tube comprising:
(A) a first layer comprising a non-fluorinated polymer having polar functionality; and
(B) a second layer comprising said melt processible semicrystalline fluoropolymer of claim 1; wherein the layers are arranged concentrically such that said first layer (A) is outside of said second layer (B) and the outer face of said second layer (B) is in contiguous contact with the inner face of said first layer (A).

25. An insulated wire comprising:
(A) a wire comprising metal; and
(B) a layer comprising said melt processible semicrystalline fluoropolymer of claim 1; wherein (A) and (B) are in contiguous contact.

26. A melt extrusion die having a flow passage coated with a composition comprising said melt processible semicrystalline fluoropolymer of claim 1.

27. A process for melt extruding a polymer, comprising:
(A) coating the flow passage of a melt extrusion die with said melt processible semicrystalline fluoropolymer of claim 1 to form a coated melt extrusion die; and
(B) melt extruding a polymer through said coated melt extrusion die.

28. An optical fiber comprising:
(A) a fiber comprising an inorganic substrate; and
(B) a layer comprising said melt processible semicrystalline fluoropolymer of claim 1; wherein (A) and (B) are in contiguous contact.
